(19) United States
(12) Patent Application Publication
(10) Pub. No.: US 2016/0249092 A1
(43) Pub. Date: Aug. 25, 2016

(54) SYSTEM AND METHOD FOR DIGITAL VIDEO RECORDING BACKFILL

(71) Applicant: LAYER3 TV, INC., Denver, CO (US)

(72) Inventor: Charles A. HASEK, IV, Denver, CO (US)

(73) Assignee: LAYER3 TV, INC., Denver, CO (US)

(21) Appl. No.: 14/630,621

(22) Filed: Feb. 24, 2015

(51) Int. Cl. H04N 21/433; H04N 21/4335; H04N 21/41; H04N 21/4147

(52) U.S. Cl. CPC H04N 21/4334; H04N 21/4147; H04N 21/4335; H04N 21/4135

(57) ABSTRACT

The present invention relates to a system and method of digital video recording of media content from a content delivery network (CDN) stored to a device such as a set-top box with integrated digital video recorder (DVR), to network digital video recorder (nDVR), or both. The system and method for DVR recording of media content recognizes and corrects non-uniform media content from different resolutions, bit-rate or other degraded fragments/segments (such as an incomplete transfer) from adaptive bit rate streaming (ABR), CDN disruptions, and other recording problems. The system and method determines instances of non-uniform media content data with file information about the media content data available from a resource manager. The file information is used to identify corresponding uniform media content data equivalent to the instances of non-uniform media content data. The system and method obtains uniform media content data using the resource manager from the CDN and replaces one or more files of the non-uniform media content data in storage with the uniform media content data so as to ensure quality in the user experience when later viewing the DVR or nDVR recording.

### FIELD OF THE INVENTION

The present invention relates to network and set-top box digital video recording (DVR) and, more particularly, to an improved system and method for recording media content on a device that recognizes and corrects varying recorded non-uniform resolutions and/or bit-rate from adaptive bit-rate streaming (ABR) systems and other recording problems from content delivery network disruptions to ensure quality in the user experience when later viewing the recording.

### BACKGROUND OF THE INVENTION

In a content delivery network when a user seeks to record digital media content (e.g. a linear broadcast event or a non-linear VOD title that has been ingested and metadata pushed into the system) video content quality can be affected by the transport over the Internet, cable system direct access line, or other communicative means. Adaptive bit-rate streaming (ABR) technologies are built for transmission over HTTP over large, broad-distribution networks involving encoding the source video at varying bit rates, and then segmenting each of the different bit rate streams into small parts, e.g. each segment length is typically set between 2 and 10 seconds. The content delivery network also writes segment information to a manifest file forming a catalog of segments and bitrates so that when a user's device requests to record digital media content the manifest file directs the player to request specific content media file segments.

When recording digital media content using ABR technology, the player on the user's device is adapted to detect the currently available bit rate download speed. Typically digital media content players request from the lowest bit rate stream given in the manifest file. If the player detects a bit rate that exceeds the bit rate of the initial segment, the player will request the next higher bit rate segment available in the manifest file should the bit rate download speed be available across the content delivery network. ABR technology then is continuously switching among the different bit rate segments—locating the segments that correspond best to the bandwidth on the user's device—and, when recording, these different bit-rate content media file segments are stored in storage on the device. Such stored non-uniform content media file segments for a particular recording may cause problems in the playback because the different bit-rate segments correspond to different display resolutions. Moreover, with typical digital video recorder (DVRs) there is no way to correct stored non-uniform content media file segments. As a result, the playback displays the movie with varying display resolutions resulting in the user watching a less than optimal recording of a video with degration, fuzziness, appearing un-focused, or with other noticeable resolution changes in high-definition HD displays.

Transmission losses also may occur for one or more frames, packets or related information of the video content, for example, scene information is lost in the transmission or communication of the linear and non-linear content. Frame, packet and information losses can be caused by a number of factors, including signal degradation over the network medium, oversaturated network links, corrupted packets rejected in-transit, faulty networking hardware, maligned system drivers or network applications, or normal routing routines. Problems can occur in recording content media when network disruptions and quality of service (QoS) degradations also cause such information losses. Similarly, such frame, packet and information losses cause problems in a user's viewing experience e.g. causing dropped MPEG frames of transmitted movies. Upon later viewing, the user discovers that frames have been dropped from the video and the recording is not entirely complete. Once recorded, the user has no means of correcting these problems utilizing conventional DVR systems and methods currently available.

Conventional network digital video recorders (nDVRs) systems and methods for recording content media on the network (i.e. sometimes referred to “in the cloud”) have similar problems from signal losses, dropped MPEG frames and storing non-uniform resolutions e.g. varying bit rates due to ABR technology. Similar problems can occur in recording content media and playback because once recorded the user has no means of correcting these problems utilizing conventional nDVR systems and methods currently available.

As a result, there is a present need to provide DVR and/or nDVR systems that record and correct linear and non-linear content with respect to dropped frames and other degradation of the originally recorded content media to optimize the playback and the user experience.

### SUMMARY OF THE INVENTION

It is an object of the present invention to provide an DVR backfill apparatus, system and method of to discover linear and non-linear non-uniform content media file segments stored for a user's recording and to correct such non-uniform content media file segments with uniform content media file segments so as to eliminate varying display resolutions and to provide optimal recording and playback to the user.

It is an object the apparatus, system and method of the present invention to overcome the disadvantages of the prior art DVR and/or nDVR systems in recording linear and non-linear content with respect to dropped frames and other degradation of the originally recorded content media.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 is a schematic diagram illustrating system and method of content delivery and recording of linear and non-linear media content in accordance with an embodiment of the present invention;

FIG. 2 is a schematic diagram illustrating the digital video recording system and method of recording linear and non-linear media content in accordance with an embodiment of the present invention; and

FIG. 3 is a flowchart illustrating the method of recording linear and non-linear media content in accordance with an embodiment of the present invention.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “DVR” refers to a device or application software that digitally compressing analog and/or video feeds and storing these feeds in memory (i.e. that records video in a digital format to a hard-drive, system memory, a disk drive, USB flash drive, SD memory card, SSD or other local or networked mass storage device, etc.). The term includes set-top boxes (STB) with direct to disk recording facility, portable media players (PMP) with recording, recorders (PMR) as camcorders that record onto Secure Digital memory cards and software for personal computers which enables video capture and playback to and from a hard disk drive. The term “digital” referring to the compression and storage technology, not the transmitted video images.

As used herein the term “network digital video recording” or “nDVR” refers to a device or application software that stores digital images or video on the network “in the cloud” (e.g. directly from the IP-network into a networked mass storage device). As used herein the term “Quality of Services” or “QoS” refers to a device or application software device is one that is capable, in order to comply with bandwidth limitations of a network, of limiting the transmission rate it uses for transmission or reception over the network. A QoS device may be capable of negotiating with a system resource manager for varying amounts of bandwidth.

As used herein the term “application programming interface” or “API” refers to a software component in terms of its operations, inputs, outputs, and underlying types is a set of routines, protocols, and tools for building software applications.

The invention is a DVR backfill system and method for recording digital content to ensure quality of the user experience is generally designated as numeral 100. According to an embodiment, the DVR backfill system and method 100 may be formed and implemented using a digital video recorder (DVR) integrated a devices (e.g. a set-top box) and/or on a network digital video recorder (nDVR). The system and method 100 provides a user the ability to backing up and playing recorded program material linear and non-linear content media (e.g. TV broadcast programs, VOD, and digital video). The system and method 100 may be implemented in a content delivery network (CDN) system using computers to distribute copies of data placed at various nodes of a network by subscription to the device of a user. According to one embodiment, the content media may be, for example, linear broadcasting and non-linear or VOD content media (audio and podcast hosting, video delivery, live streaming, flash streaming), downloadable objects (media files, software, documents), live streaming and database queries. Numerous devices are available for a user to play the content media such as TV, HD-monitors, mobile devices

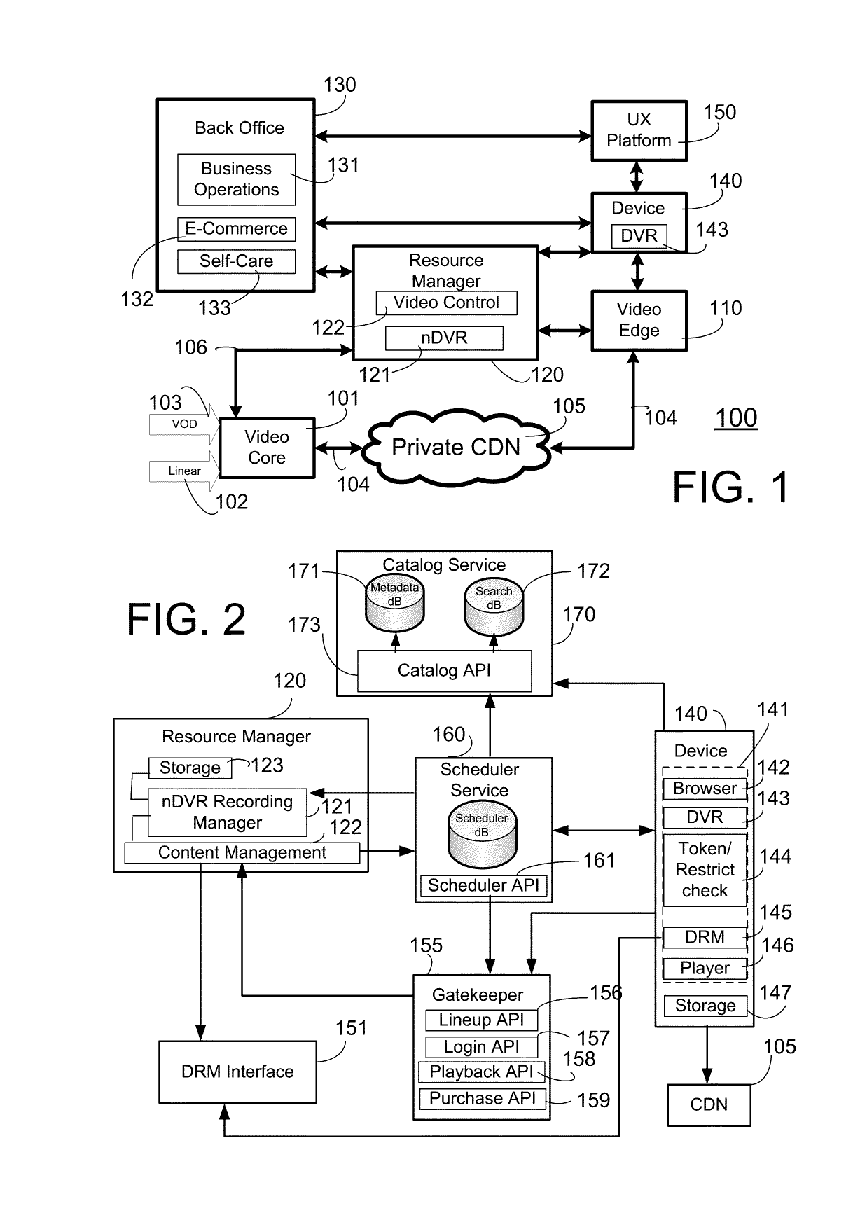

Referring to FIGS. 1 and 2, a DVR backfill system and method 100 generally comprises a video core 101 for ingesting and packaging linear 102 (e.g. live broadcasting) and non-linear 103 (e.g. video on demand (VOD)) and linear content 103 by communication lines 104 across a communication network 105 to the video edge 110 to service a device 140 (e.g. set-top box, tablet, smart phone, computer, etc.) of a user that subscribes to content subscription service. The video core 101 also communicates with a resource manager 120 over communication lines 106 to provide information about the ingested and packaged linear 102 and non-linear 103 such as, for example, by maintaining a manifest file. The system 100 also comprising a back office 130 with business operations 131 (e.g. regulations, licenses, etc.), e-commerce 132 (e.g. subscriber billing, payments, etc.) and a self-care 133 portal (e.g. updates, remote servicing of devices, etc.). The user experience platform 150 may be a multi-dimensional platform to present content media to the user in a predetermined graphical user interface (GUI). A digital rights management (DRM) interface 151 that interfaces with the user device 140 and the resource manager 120 operates in the delayed DVR system and method 100 to authorize viewing of copyrighted content according to policies and rights management across the CDN 105.

According to an embodiment, DVR backfill system and method 100 can be configured to use ABR streaming technologies to transmit the content media files over HTTP for distribution across the private CDN 105. In this manner, DVR backfill system and method 100 uses the advantages of ABR by dynamically monitoring CPU and memory capacity to make corresponding adjustments in the video quality of the transmitted content media by encoding the source linear and non-linear content (e.g. live broadcast, movie, video, etc.) at varying bit rates, and then segmenting each of the different bit rate streams. The segment length may be a predetermined size and duration, for example, between 2 and 10 seconds. The client or user's device 130 includes a player 146 to use the ABR advantageously to switch among the different bit rate segments, thereby locating the segments that correspond best to the bandwidth.

Referring to FIGS. 1 and 2, the resource manager 120 is responsible for allocating, monitoring, and controlling resources, particularly streams and bandwidth, for recording and playback related services. The resource manager 120 may integrate a network DVR (nDVR) 121 for the recording and/or playback of linear 102 and non-linear content 103 by video control 122. According to a DVR embodiment, the device 140 may integrate a DVR recorder 143 for the recording and/or playback of linear 102 and non-linear content 103 in storage on the device. It is to be appreciated that the system 100 may provide nDVR 121 in the cloud and DVR 143 on the device 120 for the user.

A CDN system may be configured as described in U.S. patent application Ser. No. 14/765,575 entitled System and Method of Distributing Content Based On Trending and Preemptive Data, which is incorporated by reference in its entirety. The CDN system, according to one embodiment, may ingest and output one or more multiple bit rate streams (e.g. MPEG streams) extracted from the analog and digital TV signal streams, for example, analog forms such as National Television Standards Committee (NTSC) or PAL broadcast, and digital forms such as Digital Satellite System (DSS), Digital Broadcast Services (DBS), or Advanced Television Standards Committee (ATSC). The video core 101 is adapted for ingesting non-linear 102 and linear content 103 media content (e.g. TV, video and/or movie content media files), packaging them in multiple bit rate streams. These streams may be communicated to the video edge 110 by, for example, using adaptive bit rate streaming (ABR).

According to an embodiment of the invention, the video core 101 is configured to ingest, segment and package the input linear 102 and non-linear 103 media content for streaming across CDN 105 to the video edge 110 for accessing by the user's device 140. A catalog of segments and bitrates is written into a manifest file that is stored on a resource manager 120 for video control 122. When the user accesses the content media file(s), the user's device 140 requests the segments from the lowest bit rate stream (given in the manifest file). If the user's player 146 detects that the download speed exceeds the bit rate of the initial segment, it will request the next higher bit rate segment (again, written in the manifest file) available the resource manager 120. This process will continue until a close match is found between the current bit rate segment and the user's available bandwidth. The player 146 will then play the content media file (e.g. video) at that bit rate. Later, if user bandwidth changes, it will request a different bit rate segment. The result—very often—is minimal buffering, quick video initialization, and a good experience on both high-bandwidth and low-bandwidth connections.

However, problems occur if the user's bandwidth decreases and lower resolution bit rate segments are stored in a recording. When the player 146 plays the content to the user, the user experience (UX) on a high-definition display will be a noticeable degradation of the video file, for example, a visual resolution drop when viewing on a High Definition (HD) display (e.g. network broadcast in either 720p60 or 1080i60 encoded with MPEG-2 or satellite broadcast signal resolution of 1080p/24-30 format with MPEG-4 AVC/H.264) to a Standard Definition (SD) resolution (e.g. a 4:3 aspect ratio with a pixel resolution of 640×480 pixels). According to another embodiment and aspect of the present invention, the DVR backfill system and method 100 overcomes these problems to detect and replace stored lower resolution files in the user's copy of the media content and create an optimum user experience.

In an exemplary embodiment, as is illustrated in FIGS. 1-2, a user has a device 140 which has may have application software 141 loaded in memory of the device 140, e.g. a set-top box or satellite DVR receiver. In establishing a recording, the device 140 checks with the gatekeeper module 188 to determine the users privileges, the user's metadata, the lineup data, performs a restrictions check such as passing an authorization token, and also may be used to purchase media content. The application software 141 may be configured as application programming interfaces (API). The application software 141 may be configured with a browser 142, a digital video recorder (DVR) 143, authorization token or restriction checker 144, a digital rights management (DRM) module 145, and content media player 146. The application software 141 is adapted to login to a gatekeeper 155 module of the resource manager 120. The gatekeeper 155 also utilizes APIs for various the subscriber data services for policies of acquisition, persistence, and consumption for the media content that may be established by the back office 130. The gatekeeper 155 can be used in recording linear 102 and non-linear 103 media content including a lineup API 156, login API 157, playback API 158 and purchase API 159.

Referring to FIG. 2, the scheduler service 160 is utilized by the system when the user scheduling that may be comprised as a scheduler API 161 and a schedule dB. The scheduler service 160 is utilized to create an event such as an impulse recording (e.g. record now) or a future recording of media content. The scheduler service 160 can be configured to communicate with the resource manager 120, the device 140 of the user, a gatekeeper 155 for effectuating policies associated with the user and/or user's subscription, and a catalog service 170. The user utilizes the scheduler service 160 to specific DVR settings and preferences default DVR scheduling settings (offset, delete priority, recording priority, series, etc.) and other user privileges. The scheduler service 160 checks with the gatekeeper 155 for authentication, entitlement check, and other account data for the particular user. The catalog service 170 for providing meta data information about the media content that is stored in a metadata database 171 and with search capabilities using a search database 172. The catalog service 170 may be implemented in a software program or catalog API 173.

According to an embodiment, the DVR backfill system and method 100 may be configured to transfer content media files (e.g. frames of video) by way of Transmission Control Protocol (TCP)/Internet protocol suite (IP). TCP/IP transfer may use a variety of protocols (e.g. HTTP, HTTPS, SMTP, POP3, IMAP, SSH, FTP, Telnet, etc.) encapsulated in TCP to transfer and deliver across the CDN network 105 from the video core 101 to the video edge 110 closest to the client device 140. When recording linear 102 and non-linear 103 media content, problems may occur with ABR streaming between the resource manager 120 and the device 140 as the recording may contain different stored resolutions because of different frame resolutions are stored due to varying bit rates and available bandwidth, for example, frames of High Definition resolutions and Standard Definition because the player ABR streaming stored non-uniform frames. In a movie, video or broadcast, frames and/or file information of the content media data are stored in a manifest file. Frames and/or file information of the content media data occur in a predetermined order based on time.

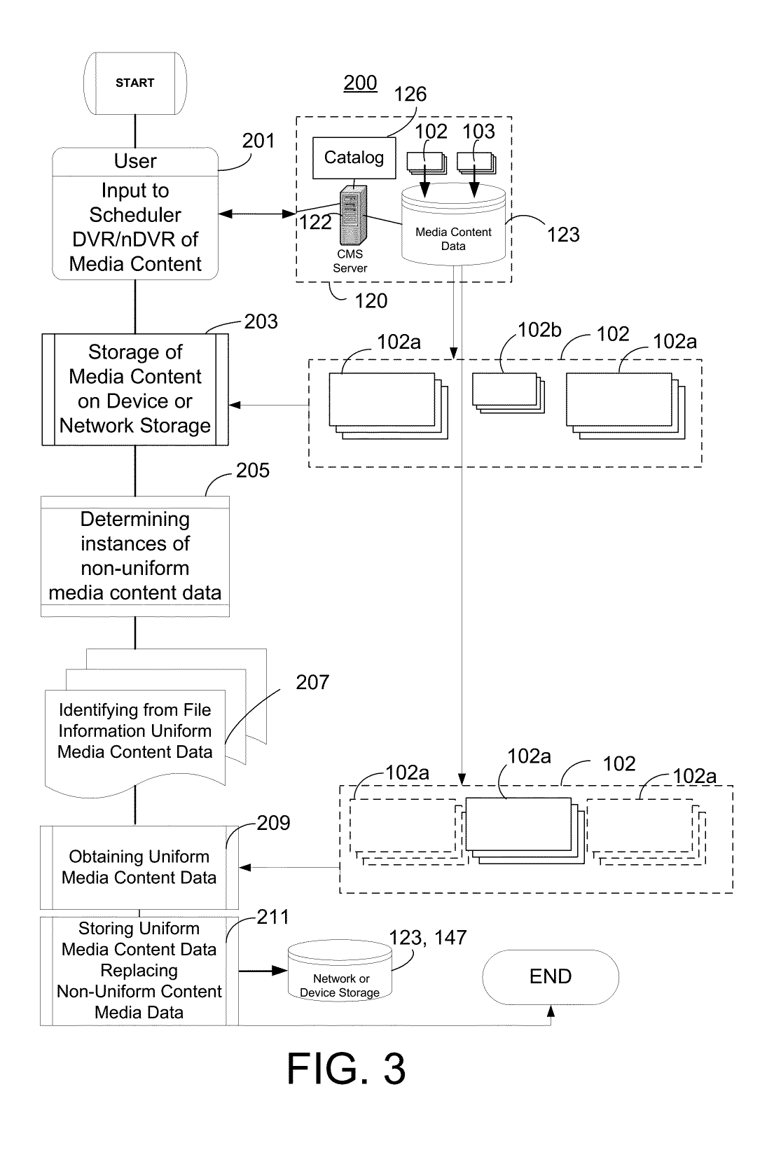

Referring to FIG. 3, in operation, the DVR backfill system and method 100 can be configured in a DVR backfill process 200 using the resource manager 120 and aspects of the CDN and system. The DVR backfill process 200 may be implemented by computer-implemented software or one or more APIs. Accordingly, the DVR backfill process 200 of the present invention described in recording a live event or linear content 102. The CDN of the present invention can segment the live broadcast stream in to multi-bit rate streams of numerous resolutions, store the streams on the system and have file information of the linear media content 102 available to the resource manager. As described herein, the DVR backfill process 200 overcomes these problems to detect and replace stored lower resolution files in the user's copy of the media content and create an optimum user playback experience.

In a Step 201, the user inputs a request to the scheduler to record the media content 102. The user may be currently watching a live stream of linear content 102. The user may use the catalog service 170 to search for live events present or in the future to watch and/or record. The scheduler 160 communicates with the resource manager 120 to obtain the desired media content 102 from storage on the CDN. The video core 101 has already segmented and stored a file information, manifest file and frames of the media content 102 in storage 123 as shown in FIGS. 2 and 3. The content manager 122 will stream the media content 101 as sequential files to the user's device 140 for recording on the DVR 143 in storage 147 and/or to the nDVR recording manager 121 and storage 123 of the resource manager. Problems occur in playback of the media content 102 when one or more uniform frame(s) 102a and non-uniform frame(s) 102b are in the stored stream of media content 102 as illustrated in FIG. 3.

In Step 203, frames or file information containing the media content data is stored in storage 147 on the device 140 or in network storage 123 of the resource manager 120. The stored stream of media content 102 includes all frames including one or more uniform media content data 102a, non-uniform media content data 102b of the files and/or frames of transmitted and stored media content 102.

In Step 205, the resource manager 120 determines from file information, the manifest file, and catalog 170 instances of non-uniform media content data 102b in the recorded stored media content 102 as is described herein.

In Step 207, the resource manager 120 identifies from file information, the manifest file, and catalog 170 where uniform media content data 102a is stored in the system e.g. network storage 123 on the resource manager 120, video core 101, video edge 110, or in other system storage locations.

In Step 209, the resource manager 120 obtains the uniform media content data 102a stored in the system e.g. network storage 123 on the resource manager 120, video core 101, video edge 110, or in other system storage locations.

In Step 211, the resource manager 120 stores the uniform media content data 102a for the non-uniform media content data 102b recorded for the content media 102 in the nDVR 122 network storage 123 on the resource manager 120 or on the device 140 storage 147. The replacement of the uniform media content data 102a for the non-uniform media content data 102b recorded for the content media 102 may be to correct a dropped frame, no recorded frame, a corrupted frame, a frame of a lower resolution (e.g. SD/HD), and other replacements to provide an optimum playback for the user's experience.

Referring again to FIG. 1, the file information order in the manifest file may be used determining the one or more frames of non-uniform media content data should be replaced to provide uniform media content data for playback by the user. The resource manager 120 is configured for content management 122, to generate manifest reports, to determine all current active streams of the user, status whenever there is a status change or as a sync operation so as to allow the resource manager 120 to sync all resource statuses with the video edge (i.e. clients) streaming content media to the user's device 140 and/or DVR 141. DVR playback is tracked by the resource manager 120. The resource manager 120 tracks and monitors all bandwidth resource usage locally. The bandwidth resource usage may be reported by the resource manager 120 as, for example, a usage report, a global resource configuration, and/or an nDVR 121 related service API in the cloud. The resource manager 120 may be adapted to push notifications to all connected clients (UX platform(s) 150 and DVR(s) 140 with the latest resource statuses.

In another embodiment of the present invention, application program software may be configured to determine if each of the content media files has the correct files size. Any network disruption in the transport and transfer of the content files, frames of the content media files will be lost from the predetermined order. The manifest file may include error-checking log file information regarding the particular the content media files and the place in the predetermined order. Any disruption in the transport and transfer of the content files, frames of the content media files will be lost from the predetermined order, register incorrect file sizes, or otherwise be logged.

The error-checking will log in a record or list on the resource manager 120 the particular the content media files and the place in the predetermined order so as to correlate errors, e.g. if a disruption in transmission occurs, file will be of a value less than the optimum and/or expected size for each content media file, for example, an indication of a degradation of one or more content media files (e.g. frames of a movie). As a movie displays the frames of the content media files sequentially, the particular (1) time and (2) position or point in the sequence. The application program software may be configured to obtain a copy of each of the degraded, non-uniform content media file(s) for the recorded content media recorded by the user. The application program software can check the network for correct uniform content media file(s) for the recorded content media. If the uniform content media file(s) are available, the application program software is configured to transmit the correct content media file(s) and replace the non-uniform content media file(s) with the uniform content media file(s) in the content media recorded by the user.

As shown in FIG. 2, the resource manager 120 may be implemented as an API designed as a component that resides on the gateway 155. The resource manager 120 is utilized for DVR recording and playback for the user experience 150 on the device 140. The resource manager 120 may be configured to determine streaming configurations based on the bandwidth for the DVR 141 function according to the user device 140.

For example, when the user tunes to a particular linear channel (or flipping through channels), the UX platform 150 requests a single linear stream from the resource manager 120. If the user navigates away from viewing linear TV the resource manager 120 will release the stream from the device 140. Once the user starts viewing a channel, the UX platform 150 may be configured to report profile changes (such as registering 4K display device in the profile) to the resource manager 140 for further video control 122 of the available bandwidth and ABR resource management.

Referring to FIG. 1, the UX platform 150 API connects and subscribes to the resource manager 120 to receive resource notifications. If the UX platform 150 is configured with a mosaic viewing experience for the user having multiple streams displayed at once, In such a system a main view and multiple other views can display multiple streams in a “mosaic” of tiles. The UX platform 150 may manage bandwidth of all the tiles on the Mosaic view, e.g. bandwidth for all mosaic tiles may utilize similar same bandwidth as a normal stream. When a user requests to view a video in full screen from a Mosaic view tile, UX kills the Mosaic view stream and requests a new stream for the full screen video. If a user goes back to the Mosaic view from playing a video (or an ongoing DVR recording is displayed in the Mosaic view), the video still consumes one stream until it gets stopped by the user. For any playback that requires an additional stream, the UX platform communicates with the resource manager 120 to request the stream.

In operation, the resource manager 120 can be configured to determine whether a stream may be allocated based the resources, policies, and applicable number of rules such as by the content management 122 and token restriction check 144. The resource manager 120 then broadcasts the list of streams with their latest statuses to all connected devices 140 to UX platform 150 of clients and to the DVR 143 function. The UX platform 150 may present the information to the device 140 of a user as needed to resolve resource conflicts such as, for example, the user may choose to end some conflicting streams to manually resolve the conflict. For any user actions that cause bandwidth resource changes, which include a stream starts and a stream stops, the UX platform 150 must report such events to the resource manager 120. The resource manager 120 will update the resource statuses accordingly. The UX platform 150 is configured to have the user's DVR 143 report to the resource manager 120 with current statuses of its streams.

The resource manager 120 broadcasts the list of streams including active streams and terminated/stopped/blocked streams to all connected UX platform 150 clients and Recorder. The UX platform 150 must process such notifications and take actions when necessary. DVR 143 connects and subscribes to the resource manager 120 to receive resource notifications. Near recording start time, whether it is X minutes (X is configurable by the DVR 143) or immediately before a recording starts (for impulse recordings), the DVR 143 must communicate with the resource manager 120 to request resource for a recording to start.

The resource manager 120 determines whether a stream can be allocated based on a number of rules. The resource manager 120 then broadcasts the list of active streams and terminated streams to all connected UX platform 150 clients and the DVR 143. The UX platform 150 may present the information to the user as needed. In case of resource conflict, the user may choose to end some conflicting streams to manually resolve the conflict. If a recording cannot be started due to conflict constraints, the DVR 143 reports the blocked (or failed?) status back to the Scheduler Service 160. For any events that cause resource changes, which include a recording starts/stops/fails, the DVR 143 must report such events to the resource manager 120. The resource manager 120 will update the resource statuses accordingly. The resource manager 120 broadcasts the list of streams including active streams and terminated/stopped/blocked streams to all connected UX platform 150 clients and DVR 143. The DVR 143 must process such notifications and take actions when necessary.

While certain configurations of structures have been illustrated for the purposes of presenting the basic structures of the present invention, one of ordinary skill in the art will appreciate that other variations are possible which would still fall within the scope of the appended claims. For example, while the content media 132, 133 may be stored on the set-top box device 181, the content media files may be stored on network storage for playback upon request from the client 180. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system for managing a transmission of media content over an access link between a device of a user and a source of the media content in a content delivery network (CDN), the system comprising:
a scheduler configured to:
operate in connection with a digital video recorder, whereby said scheduler is configured to schedule the recording of a media content data at a predetermined time using a digital video recording (DVR) by the user communicating a selection to a resource manager;
a resource manager configured to:
receive said service request from said scheduler for delivery of said media content data,
identify said media content data of said service request for delivery;
process said service request by determining one or more user characteristics of said request for delivery of said media content data;
store said media content data in storage located in said CDN;
determine instances of non-uniform media content data with file information of said media content data available to said resource manager; and
identify from said file information locations in a manifest file of corresponding uniform media content data equivalent to said instances of non-uniform media content data in the CDN; and
a content processing and communication system communicatively coupled with said resource manager and configured to:
replace one or more files of said non-uniform media content data in storage with said uniform media content data;
deliver said uniform media content data using said resource manager to said user; and
store said media content data in storage located in said requesting device.

2. The system of claim 1 wherein said content processing and communication system is configured to store said media content data in storage located in said a user device.

3. The system of claim 1 wherein said content processing and communication system communicates is further configured to store said media content data in storage of said resource manager located in said CDN.

4. A method of digital video recording of media content from a content delivery network (CDN), comprising, the steps of:
scheduling the recording of a media content data at a predetermined time using a digital video recording (DVR) by a user communicating a selection to a resource manager;
storing said media content data in storage located in said CDN;
determining instances of non-uniform media content data with file information of said media content data available to said resource manager;
identifying from said file information corresponding uniform media content data equivalent to said instances of non-uniform media content data;
obtaining said uniform media content data using said resource manager from said CDN; and
replacing one or more files of said non-uniform media content data in storage with said uniform media content data.

5. The method of claim 4, wherein said scheduling step further includes said predetermined time is now available said media content as displayed by a catalog service adapted to display said predetermined time(s) of said scheduling of said digital video recording linear or non-linear media content.

6. The method of claim 4, wherein said scheduling step further includes said predetermined time is in a future available from a catalog service adapted to display said future time for said scheduling of said digital video recording linear or non-linear media content.

7. The method of claim 4, wherein said storing step further includes storing said media content data in storage is located in storage of a user device.

8. The method of claim 4, wherein said storing step further includes storing said media content data in storage is located in storage of the resource manager on the network.

9. The method of claim 4, wherein said step of determining instances of non-uniform media content data with file information compares bit rate information of said media content data.

10. The method of claim 4, wherein said step of determining instances of non-uniform media content data with file information compares bit rate information of said media content data.

11. The method of claim 4, wherein said step of determining instances of non-uniform media content data with file information compares file size information from said file information with an actual stored file size information of said media content data stored on said device.
